(19) United States
(12) Patent Application Publication
(10) Pub. No.: US 2005/0125353 A1
(43) Pub. Date: Jun. 9, 2005

(54) Management and deployment of versioned content and metadata

(75) Inventors: David Schlesinger, Carlisle, MA (US); Robert Yates, Cambridge, MA (US)

Correspondence Address: CHRISTOPHER & WEISBERG PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/727,207

(22) Filed: Dec. 3, 2003

(51) Int. Cl. G06F 17/60

(52) U.S. Cl. 705/51

(57) ABSTRACT

The present invention is a method, system and apparatus for updating a course delivered through a learning management system. In a method for selectively applying course updates in a learning management system, an update to course metadata can be processed without also processing an update to course content in the learning management system. Additionally, a course metadata update to an associated course master can be identified within a course package. Subsequently, it can be determined whether to wholly reject the update to the associated course master, or to apply the update to the associated course master. It further can be determined whether to apply the update to the course metadata to existing course offerings based upon the associated course master, or whether to exempt the existing course offerings from the update to the associated course metadata.

### BACKGROUND OF THE INVENTION

1. Statement of the Technical Field

The present invention relates to the field of application content distribution, and more particularly to the management and deployment of on-line course offerings in a learning management system.

2. Description of the Related Art

Learning management systems provide for the total management of an on-line learning experience—from content creation to course delivery. In the prototypical learning management system, one or more course offerings can be distributed about a computer communications network for delivery to students enrolled in one or more corresponding courses. The course offerings can include content which ranges from mere text-based instructional materials to full-blown interactive, live classroom settings hosted entirely through the computer communications network. So advanced to date has the ability of learning management systems to deliver content become, that nearly any learning experience formerly delivered through in-person instruction now can be delivered entirely on-line and even globally over the Internet.

The conventional learning management system can include a learning management server configured to manage the introduction and distribution of course materials to enrolled students. The learning management server further can be configured to import course content and the structure and arrangement of the course content created both by coupled authoring tools and third party authoring tools which can package course content according to any one of the well known course content packaging standards, such as the ADL Shareable Content Object Reference Model (SCORM) and AICC. Once imported, online course instances can be created based upon a course master reflecting the packaged course content and metadata describing the structure and arrangement of the course content. The on-line course instances can be cataloged for public availability to registered students and the content reflected within the on-line course instances can be distributed to the students on-demand.

The conventional learning management system can read and access standards-based metadata relating to course content. In this regard, by creating a metadata file for a course or module, content can be accessed more readily by the end user and shared across different delivery systems. Thus, having a standardized set of metadata makes cataloging and sharing easier. Also, using this type of metadata, the learning management system can appropriately structure and arrange the content within the course instance for suitable presentation to those who would access instances of the course.

Courses in the learning management system context can be produced by course developers having both the knowledge and also the skills to create an on-line learning experience that is both effective and also fun. As individuals or teams, course developers must be adept in all aspects of on-line education: as experts in a certain subject area, as Web developers experienced with course development software, as Web designers who can create visually appealing screens, and as instructional designers who understand on-line teaching strategies. When course developers design a course content screen, they consider the visual and auditory impressions, as well as the student's own interactions with the screen in order to create a complete learning experience. Each screen must also blend with the context and design of other screens and contribute to the instructional goals for the course.

Courses can include both course content and metadata. To ensure that a course consistently maintains the appeal necessary to meet the instructional goals for the course, course developers constantly provide updates to the course content and course structure reflected in the metadata. Other times, the updates can include modifications only to the course metadata. To process changes to a course at present, whether content, metadata or both, the entire course package can be uploaded into the learning management server as a complete replacement to an existing course package. Alternatively, the updated course package can be added to the learning management system as a new course offering which logically supercedes the existing course without physically replacing the existing course. In either case, the updating of the course content cannot be separated from the updating of associated metadata. Hence, the process can be viewed strictly as a rigid process.

### SUMMARY OF THE INVENTION

The present invention addresses the deficiencies of the art in respect to the rigid content updating process of conventional content deployment and provides a novel and non-obvious method, system and apparatus for selectively and flexibly updating courses in a learning management system. In a preferred method for selectively applying course updates in a learning management system, an update to course metadata can be processed without also processing an update to course content in the learning management system. Specifically, a course metadata update to an associated course master can be identified within a course package. Subsequently, it can be determined whether to wholly reject the update to the associated course master, or to apply the update to the associated course master.

It further can be determined whether to apply the update to the course metadata to existing course offerings based upon the associated course master, or whether to exempt the existing course offerings from the update to the associated course metadata. Notably, the course package can include both a course package identifier and a version indicator. As such, when uploaded the package identifier can be extracted for the course package and the identifier can be compared with other identifiers associated with existing course masters disposed within the learning management system. In this way, the identifying, determining and further determining steps can be performed only where the comparison indicates that the course package incorporates the update.

Notably, in addition to the identifier and version indicator for the course package, an identifier and version indicator can be included for each of the course content and the course metadata. In this way, an inspection of the course package can reveal whether the course content, the course metadata, or the course content and metadata have changed. To the extent that only the course metadata has changed, it will only be necessary to update the course metadata and not the course content, resulting in inherent efficiencies in that the course content which can be large in size need not be processed in the course of the update procedure.

In any case, once it has been determined that an update to the course master has been included within the course package, the existing version of the course master can be marked for updating by including the course master within a list of course masters slated for update. Optionally, however, the update can be wholly rejected so that the associated course master already existing within the learning management server is not to be replaced with the updated course master. When the update has been wholly rejected, the listing can be removed so that the update to the associated course master will not occur.

The foregoing method can be incorporated within a method for updating a course delivered through a learning management system. In this regard, the method can include authoring a course metadata update to an existing course deployed within the learning management system. The authoring step can be performed either in a stand-alone authoring tool, or within an authoring tool which has been integrated with the learning management system. The update can be packaged into a course package and imported into the learning management system either directly in the case of an integrated authoring tool, or indirectly through intermediate import logic. Subsequently, it can be selectably determined whether to apply the course metadata update to all course offerings for the existing course, or only to new course offerings for the existing course.

The methods of the invention can be performed in the context of an updateable learning management system. In accordance with the present invention, an updateable learning management system can include a learning management server coupled to a delivery server. A database can be coupled to the learning management server and configured to store course masters arranged to describe course offerings for deployment in the delivery server. Finally, update logic can be disposed within the learning management server.

The update logic can include programming for selectively updating course offerings disposed in the delivery server with one of updated course metadata alone, updated course content alone, and both updated course metadata and course content, based upon a course update package uploaded into the learning management server. Importantly, the updateable learning management system also can include an authoring tool programmed to produce update packages for importation into the learning management server. Finally, the updateable learning management system, can include a content server configured to be responsive to the delivery server for delivering course content to requesting clients in association with particular ones of the course offerings disposed in the delivery server.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a learning management system configured for selectively managing and deploying updates to courses; and,

FIG. 2 is a flow chart of a process for selectively managing and deploying updates to courses for use in the learning management system of FIG. 1.

### DETAILED DESCRIPTION OF THE PREFERRED EMBODIMENTS

The present invention is a system, method and apparatus for selectively updating courses in a learning management system. In accordance with the present invention, updated course packages can be processed to determine whether the course package includes an update to the course content, the course metadata, or both. Where the updated package includes an update to the course metadata, the course master can be updated with the new course metadata. Subsequently, it can be determined whether to accept or reject the application of the update to existing or subsequent course offering. Where the update has not been rejected, it further can be determined whether the update is to be applied to existing course offerings or only to subsequently created offerings while existing offerings can be exempted from the update.

Notably, by applying the update only to subsequent offerings, the progress data associated with the existing offerings can be preserved. Also, by applying the flexibility of distinguishing an update to course content from course metadata, it will not always be necessary to package content with the metadata in an update. In consequence, course updates can be kept to a minimal size thereby providing for a more efficient update process. Finally, by permitting the selective application of course updates, whether to content, metadata or otherwise, a finer control over the updating process in the learning management system can be exercised by the administrator of the learning management system.

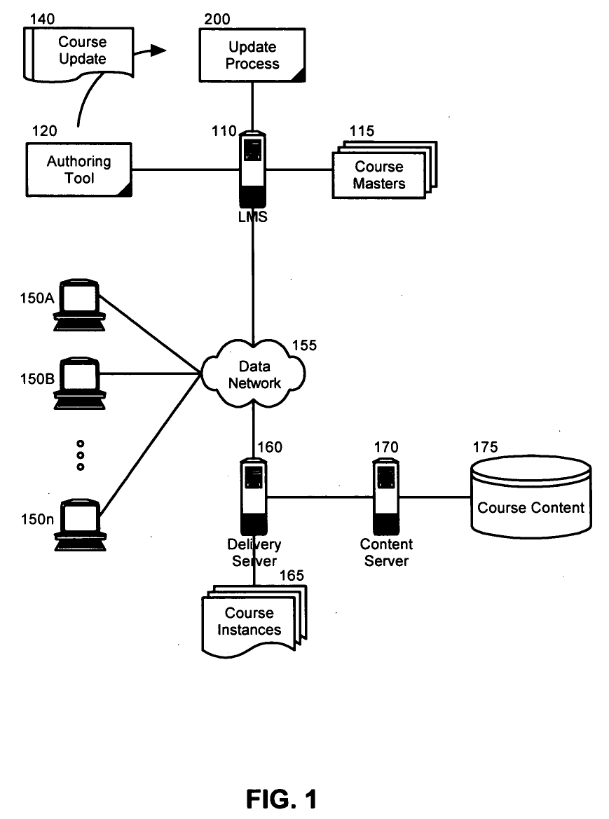

FIG. 1 is a schematic illustration of a learning management system configured to selectively manage and deploy updates to course material. The learning management system can include a learning management server 110 coupled to one more client computing devices 150A, 150B, 150n over a computer communications network 155. The learning management server 110 can include a database management system (not shown) to manage users, enrollment, course catalog an resources. The learning management server 110 further can include reporting, calendaring, messaging and scheduling logic.

An authoring tool 120 can be coupled to the learning management server 110. The authoring tool 120 can provide logic for creating course content for distribution to students of the learning management system. The authoring tool 120 further can provide logic for packaging the course content and associated metadata into a distributable course package. Importantly, the present invention is not limited to the direct coupling of an authoring tool 120 to the learning management server 110. Rather, in an equally preferred embodiment, the authoring tool 120 can remain uncoupled from the learning management server 110 which can asynchronously process course content created in the authoring tool 120. In any case, once course content has been uploaded into the learning management server 110, a course master 115 can be created for the content and the metadata the course master 115 can be cataloged for access by the clients 150A, 150B, 150n.

Students can search the course catalog on the learning management server 110 to locate a specific course offering. Once a desired offering has been located, the students can enroll in the course offering. Responsive to the enrollment, the students can access the content for the selected offering in a designated delivery server 160. More particularly, a delivery server 160 can be coupled to the learning management server 110 over the data communications network 155. The delivery server 160 can be configured to render a user interface for the delivery of course content 175 for specific course offerings 165 to the clients 150A, 150B, 150n over the data communications network 155. In this regard, a communicatively coupled content server 170 can serve course content 175 to the clients 150A, 150B, 150n at the behest of the delivery server 160.

Significantly, it is a distinct advantage of the system of FIG. 1 that course updates 140 to specific courses can be selectively processed based upon whether the updates 140 includes updates to course metadata 180, course content 185, or both. In particular, in the case of a conventional learning management system, updates to courses require the updating both of the course content and course metadata, even where a change has occurred in only the course metadata. It will be recognized that to apply a complete updating of both course content and course metadata to the existing course offerings where only a change to the course metadata is required can be inefficient. Moreover, to update an entire set of course offerings to accommodate a mere change in course metadata further can be disruptive to the existing course offerings and can result in the loss of progress data for students enrolled in the existing course offerings.

In accordance with the present invention, however, as shown in the system of FIG. 1, course updates 140 can be selectively applied based upon whether the updates 140 include only changes to course metadata 180, course content 185, or both. Moreover, even where a course update 140 includes changes to course content 185, the entire course update 140 need not be absolutely applied to all course offerings. To that end, an update processor 200 can be coupled to the learning management server 110 and can provide the logic for limiting or freely permitting the updating of course masters and course offerings as the case may be.

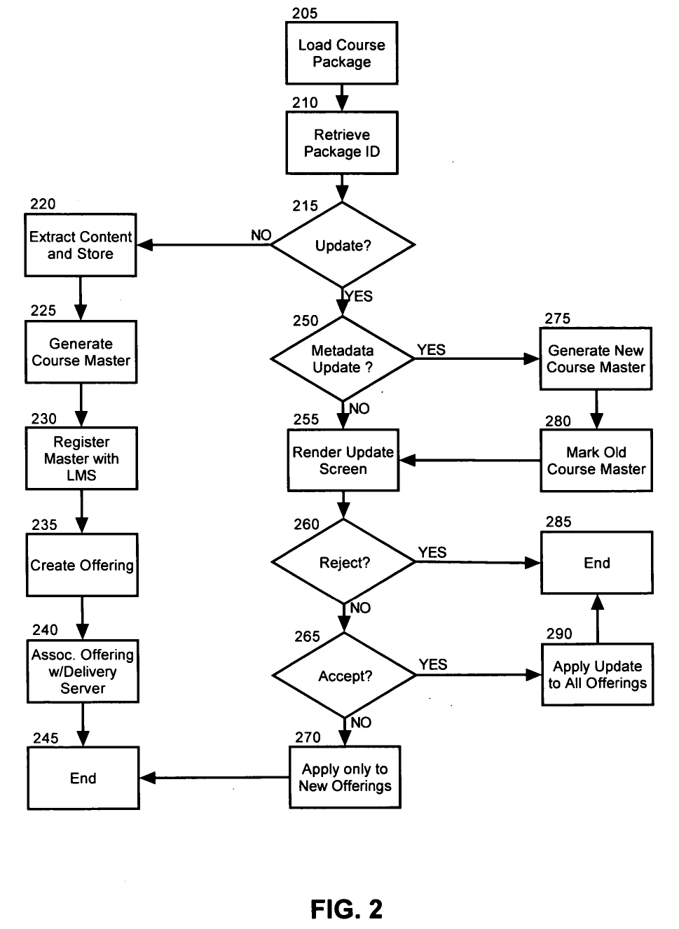

In more particular illustration, FIG. 2 is a flow chart of a process for selectively managing and deploying updates to course content for use in the learning management system of FIG. 1. Beginning in block 205, a course package created with an authoring tool can be loaded for processing. The course package can include both content and metadata regarding the content. In particular, the metadata can include versioning information for each of the package, content and metadata, In block 210 a package identifier can be retrieved for comparison to existing packages in the learning management server. Importantly, where the package identifier matches the identifier for a package already persisted in the learning management server, it can be presumed that the package is an update to the persisted package. Otherwise, it can be presumed that the package is new to the learning management server.

In decision block 215, it can be determined whether the package represents an update to an existing course in the learning management sever, or whether the package is new to the learning management server. If the package is new to the learning management server, in block 220 the content can be extracted from the package and stored in the learning management server. Additionally, in block 225 a course master can be created for the learning content and the respective metadata. In block 230 the course master can be registered with the learning management system so that end users can access the course master. Finally, in block 235 a course offering can be created from the course master and in block 240 the course offering can be associated with a specific delivery server. The process can end in block 245.

Returning now to decision block 215, the course update metadata can be inspected to identify versioning information for the course content and the course metadata. Based upon the versioning information for the content and metadata, it can be determined whether the course update includes only updated content, metadata or both. In this regard, if in block 250 it is determined that the metadata for the course has been updated, it will be necessary to generate a new course master for the course in block 275. Moreover, the existing course master can be added to a list of masters slated for updating.

In block 255 an update screen can be rendered prompting an administrator of the learning management to select the extent of the updating process for each of the marked course masters in the list. The update screen particularly can indicate whether the update applies to content, metadata or both. Regardless, in decision block 260, a series of optional update selections can be presented to the administrator. First, in decision block 260 the administrator optionally can reject the updating of the master and the course offerings. By selecting this option, the administrator indicates a desire to not affect the operation of current or future course offerings by the update. Further, by selecting this option the course master can be removed from the list of masters slated for a pending update and the process can end in block 285.

Otherwise, in block 265, it can be determined whether to apply the update not only to subsequent course offerings stemming from the course master, or to both existing and subsequent course offerings. If it is determined that the update should apply to all course offerings, present and future, in block 290 the update can be applied to all course offerings. Otherwise, in block 270 the update will be applied only to new course offerings. In this way, the progress data for existing course offerings will not become affected by the update process.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method for selectively applying course content updates in a learning management system, the method comprising the step of processing an update to course metadata without also processing an update to course content in the learning management system.

2. The method of claim 1, further comprising the steps of
identifying within a course package a course metadata update to an associated course master;
determining whether to wholly reject said course metadata update to said associated course master, or to apply said course metadata update to said associated course master;
further determining whether to apply said course metadata update to existing course offerings based upon said associated course master, or whether to exempt said existing course offerings from said course metadata update

3. The method of claim 2, further comprising the steps of:
extracting a package identifier for said course package;
comparing said identifier with other identifiers associated with existing course masters disposed within the learning management system; and,
performing said identifying, determining and further determining steps only where said comparison indicates that said course package incorporates said update.

4. The method of claim 2, further comprising the steps of:
listing said associated course master in a list of course masters slated for update; and,
removing said listing responsive to wholly rejecting said course metadata update to said associated course master.

5. A method for updating a course delivered through a learning management system, the method comprising the steps of:
authoring a course metadata update to an existing course deployed within the learning management system;
packaging said course metadata update in a course package without also packaging course content in said course package and importing said course package into the learning management system; and,
selecting whether to apply said course metadata update to all course offerings for said existing course, or only to new course offerings for said existing course.

6. An updateable learning management system comprising:
a learning management server coupled to a delivery server;
a database coupled to said learning management server and configured to store course masters arranged to describe course offerings for deployment in said delivery server; and,
update logic disposed within said learning management server, said update logic comprising programming for selectively updating course offerings disposed in said delivery server with one of updated course metadata alone, updated course content alone, and both updated course metadata and course content, based upon a course update package uploaded into said learning management server.

7. The updateable learning management system of claim 6, further comprising an authoring tool programmed to produce update packages for importation into said learning management server.

8. The updateable learning management system of claim 6, further comprising a content server configured to be responsive to said delivery server for delivering course content to requesting clients in association with particular ones of said course offerings disposed in said delivery server.

9. A machine readable storage having stored thereon a computer program for selectively applying course updates in a learning management system, the computer program comprising a routine set of instructions which when executed by the machine cause the machine to perform the step of processing an update to course metadata without also processing an update to course content in the learning management system.

10. The machine readable storage of claim 9, further comprising the steps of
identifying within a course package a course metadata update to an associated course master;
determining whether to wholly reject said course metadata update to said associated course master, or to apply said course metadata update to said associated course master;
further determining whether to apply said course metadata update to existing course offerings based upon said associated course master, or whether to exempt said existing course offerings from said course metadata update

11. The machine readable storage of claim 10, further comprising the steps of:
extracting a package identifier for said course package;
comparing said identifier with other identifiers associated with existing course masters disposed within the learning management system; and,
performing said identifying, determining and further determining steps only where said comparison indicates that said course package incorporates said update.

12. The machine readable storage of claim 10, further comprising the steps of:
listing said associated course master in a list of course masters slated for update; and,
removing said listing responsive to wholly rejecting said course metadata update to said associated course master.
